(19) United States
(12) Patent Application Publication
(10) Pub. No.: US 2013/0186241 A1
(43) Pub. Date: Jul. 25, 2013

(54) HANDBRAKE WRENCH

(71) Applicant: Marc Edgar Lagerway, Calgary (CA)

(72) Inventor: Marc Edgar Lagerway, Calgary (CA)

(21) Appl. No.: 13/356,030

(22) Filed: Jan. 23, 2012

(51) Int. Cl. B25B 13/02

(52) U.S. Cl. 81/119

(57) ABSTRACT

An apparatus for turning a railway handbrake wheel having an axis of rotation and a circumferential wheel rim located along a wheel plane perpendicular to said axis spaced apart from said axis by spokes may comprise an inner block engagable upon an inner surface of the wheel rim, an outer block engagable upon an outer surface of the wheel rim, a connector extending between and fixedly connected to the inner and outer blocks and a handle extending from the outer block.

### BACKGROUND OF THE INVENTION

1. Field of Invention

The present invention relates to handbrakes in general and in particular to an apparatus for applying torque to a railway handbrake wheel.

2. Description of Related Art

Handbrakes are commonly known and may be of many known types. In particular, handbrake wheels are commonly utilized on railway cars commonly having a mechanical linkage to apply a friction pad into contact with the wheels of the train car. Such brakes often have a hand wheel which is located in a position which may be accessed by a brakeman or other railway personnel. The hand wheel is operably connected to the brake mechanism so as to engage the brake when the hand wheel is turned. Due to the large amount of braking force required to arrest or slow the movement of a rail way car, such hand wheels may also require a relatively large amount of force to turn.

Several difficulties are known to exist with the operation of conventional handbrake wheels. In particular, the brake mechanism as well as any associated linkages may be exposed to the weather, corrosion, mud, snow and ice may become accumulated around such moving parts making their movements more difficult. Accordingly a greater force may therefore be necessary to turn such a wheel. Additionally, due to the outdoor environments, the wheel may become coated in water, mud or snow and ice making it more difficult to grip by a user.

### SUMMARY OF THE INVENTION

According to a first embodiment of the present invention there is disclosed an apparatus for turning a railway handbrake wheel having an axis of rotation and a circumferential wheel rim located along a wheel plane perpendicular to said axis spaced apart from said axis by spokes. The apparatus comprises an inner block engagable upon an inner surface of the wheel rim, an outer block engagable upon an outer surface of the wheel rim, a connector extending between and fixedly connected to the inner and outer blocks and a handle extending from the outer block.

The handle may extend substantially radially from the handbrake wheel when the inner and outer blocks are applied thereto. The inner block may have a curved profile. The curved profile may be selected to correspond to the connection between a spoke and rim of a railway handbrake wheel. The curved profile may have a radius selected to be less than 30 inches. The inner and outer blocks may be fixedly secured to the connector in opposition to each other with a space therebetween. The space may be selected to be between 0.25 and 6 inches. The connector may extend substantially parallel to the plane of the wheel plane to a first side of the first and second blocks.

The outer block may include a raised edge extending therefrom in a direction towards the inner block at an opposed side from the connector. The inner block may include a raised edge extending therefrom in a direction towards the outer block at an opposed side from the connector.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a railway handbrake wheel having an apparatus for applying rotational torque applied thereto according to a first embodiment of the present invention.

FIG. 2 is a perspective view of the apparatus of FIG. 1.

FIG. 3 is a cross sectional view of the apparatus of FIG. 1 taken along the line 3-3.

FIG. 4 is a top plan view of the apparatus of FIG. 1 being applied to the railway handbrake wheel in a first position.

FIG. 5 is a top plan view of the apparatus of FIG. 1 being applied to the railway handbrake wheel in a second position.

FIG. 6 is a side view of the gripping head of the apparatus of FIG. 1.

### DETAILED DESCRIPTION

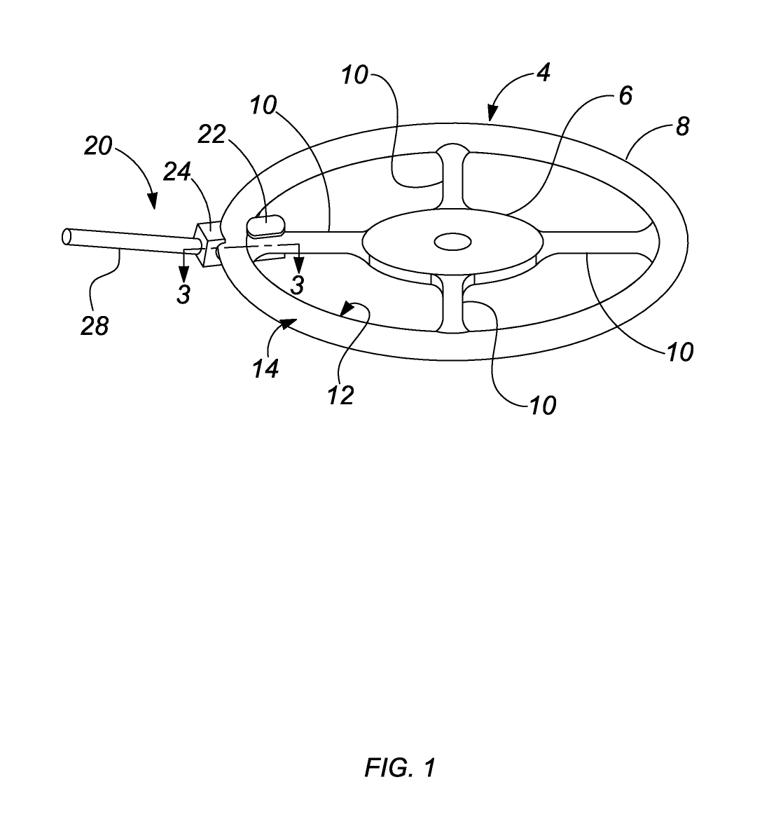

Referring to FIG. 1, an apparatus according to a first embodiment of the invention is shown generally at 20. The apparatus 20 is useful as a wrench for application to a handbrake wheel 4 as are commonly found on railway cars and the like. The handbrake wheel 4 comprises a central hub 6 and an outer rim 8 connected by a plurality of spokes 10. The outer rim 8 includes an inner surface 12 and an outer surface 14.

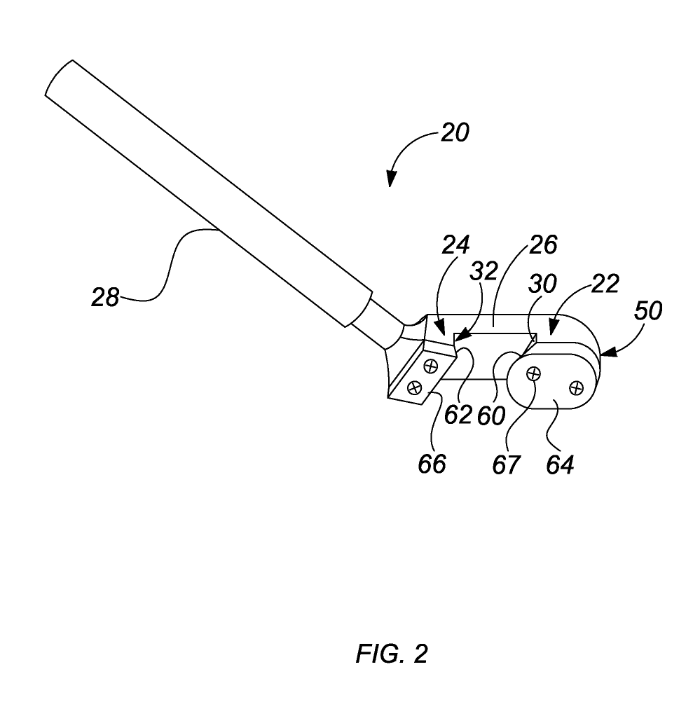

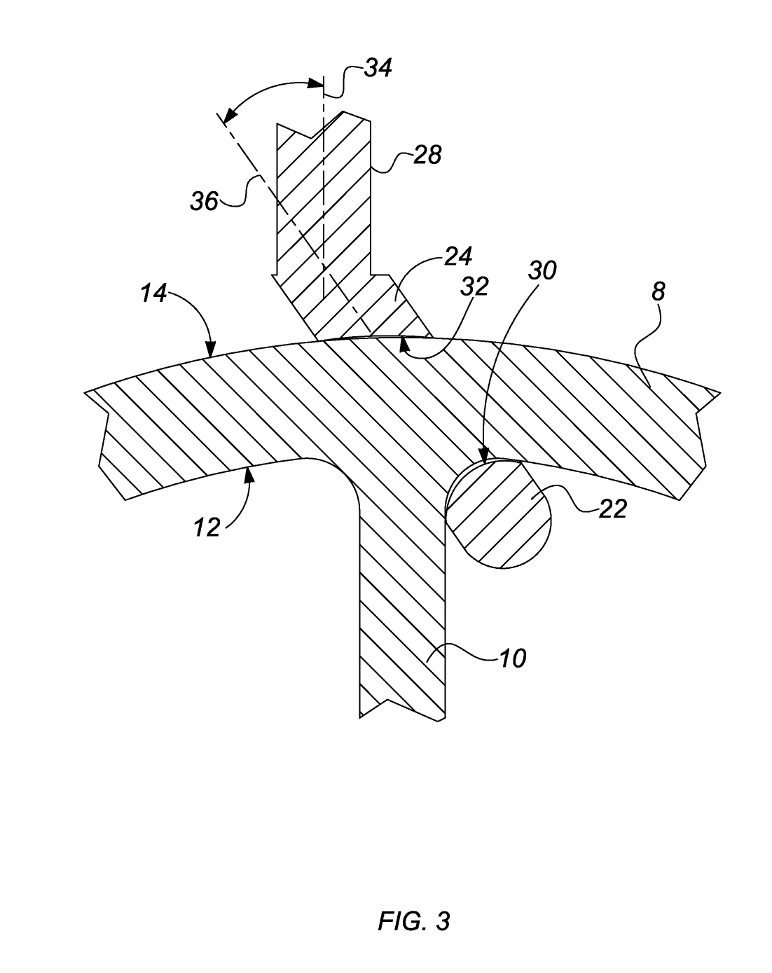

With reference to FIG. 2, the apparatus 20 comprises inner and outer blocks, 22 and 24, respectively engagable around the rim having a connector 26 extending therebetween and a handle 28 extending from the outer block 24. The inner and outer blocks 22 and 24 comprise bodies having in inner and outer opposed engaging surface 30 and 32, respectively forming a void for gripping the rim 8 therebetween. The inner and outer engaging surfaces 30 and 32 are spaced apart by a distance sufficient to receive the rim 8 therebetween. In particular, the inner and outer engaging surfaces 30 and 32 are spaced apart by a distance to receive rims 8 of different diameters and radiuses therein. Accordingly, the inner and outer engaging surfaces are spaced apart by a distance sufficient to receive such varying rims therein. In practice, it has been found that a distance of between 0.25 and 6 inches (6 and 152 mm) has been useful although it will be appreciated that other distances may be useful as well. The connector 26 comprises an elongate member having sufficient length to extend between the inner and outer blocks 22 and 24 and fixedly secure the inner and outer blocks thereto. Additionally, as illustrated in FIG. 3, the inner and outer engaging surfaces 30 and 32 may be angularly oriented relative, such as by an angle of approximately 45 degrees, by way of non-limiting example to each other so as to facilitate engagement on rims 8 having a range of cross-sections and diameters.

With reference to FIG. 3, in operation, the apparatus may be placed over the rim 8 such that the inner engaging surface 30 is engage upon the inner surface 12 of the rim 8 while the outer engaging surface 32 is engaged upon the outer surface 14 of the rim. In such a way, the apparatus 20 grips the rim therebetween. Additionally, as illustrated in FIG. 3, the inner engaging surface 30 may be engaged upon the inner surface 12 of the rim 8 at a location proximate to one of the spokes 10 of the wheel. In such a way, the apparatus 20 will be maintained at a fixed location on the rim 8. As illustrated in FIG. 3, the inner surface may have a profile corresponding to the intersection between the rim and spoke of a wheel, such as by way of non-limiting example, a radiused or chamfered profile. It will be appreciated that any radius for the inner engaging surface 30 may be utilized depending upon the handbrake wheel with which it is intended to operate. In particular, it has been found that a radius of less than 30 inches (762 mm) has been useful although it will be appreciated that other radiuses may be useful as well. As illustrated in FIG. 3, the outer engaging surface 32 may have a substantially planar surface or may also be profiled to correspond to the outer surface 14 of the rim 8.

As set out above, the handle 28 extends from the outer block 24 so as to extend substantially radially from the wheel 4 when the apparatus is applied thereto. As illustrated in FIG. 3, the handle may have an axis, generally indicated at 34 while the inner and outer blocks 22, 24 and 26 extend along a gripping axis, generally indicated at 36 with an offset angle, generally indicated at 38 therebetween. In practice, it has been found that an offset angle of between 15 and 45 degrees has been useful although it will be appreciated that other angles may be useful as well.

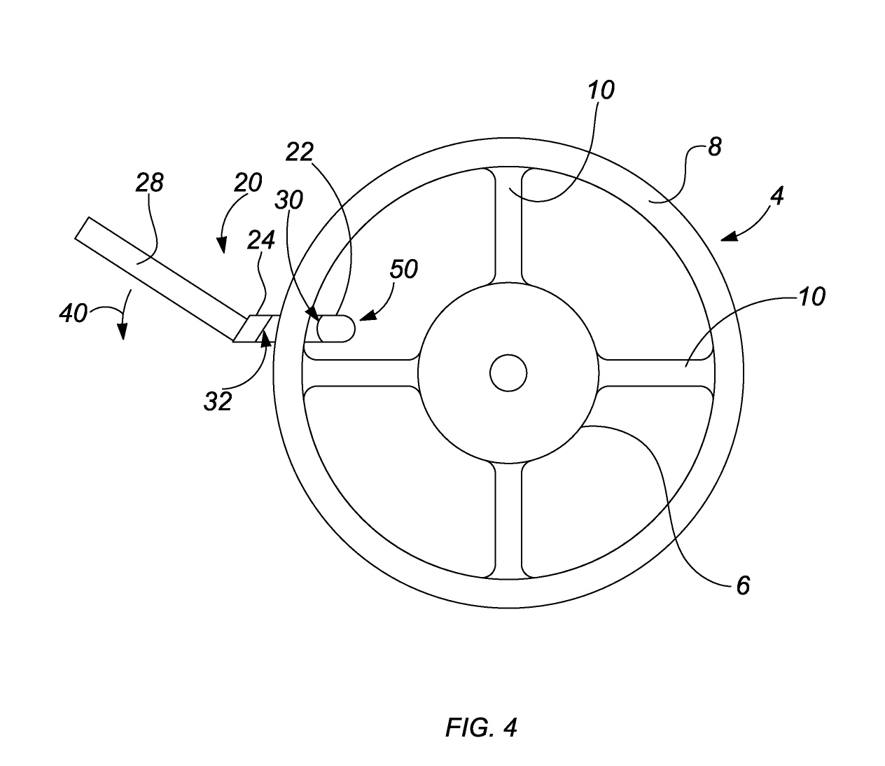

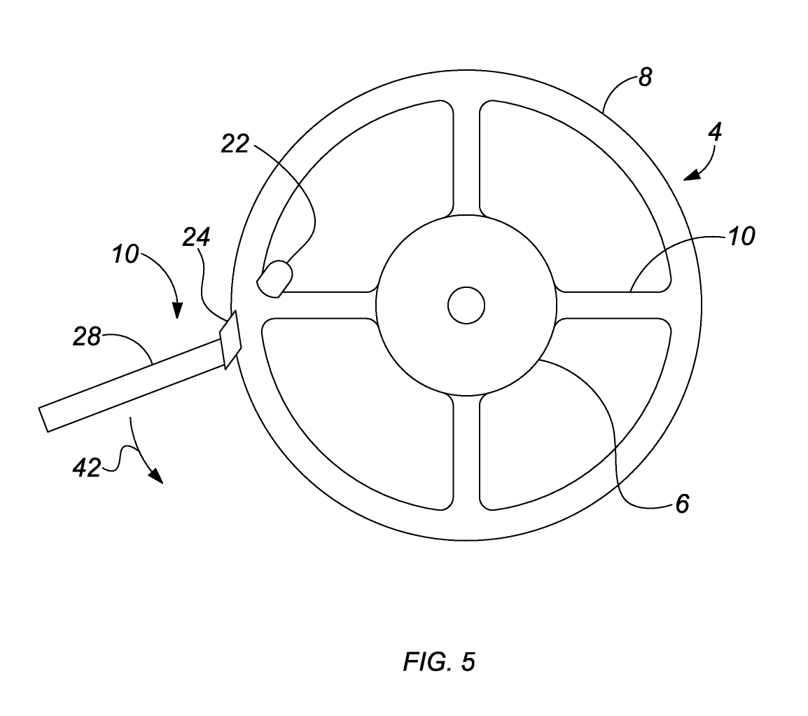

With reference to FIGS. 4 and 5, in operation, the apparatus 20 may be applied to a handbrake wheel 4 by locating the rim 8 of the wheel 4 within the space between the inner and outer engaging surfaces 30 and 32 as illustrated in FIG. 4. Thereafter the handle 28 may be rotated in a direction, generally indicated at 40 corresponding to the direction that the wheel is desired to be turned until the inner engaging surface engages upon a proximate spoke 10. Thereafter the outer engaging surface 32 is rotated into engagement with the outer surface 14 of the rim 8 to an engaged position as illustrated in FIG. 5. It will be appreciated that for rims 8 having larger diameters or cross sections, the handle will be rotated by a reduced degree to bring the outer engaging surface 32 into contact with the outer surface 14 of the rim. For rims 8 having smaller diameters or cross sections, the handle 28 will be rotated by a larger degree to bring the outer engaging surface 32 into contact with the outer surface 14 of the rim. Once the apparatus 20 is located in an engaged position, the handle 28 may be urged in the desired direction generally indicated at 42 as illustrated in FIG. 5 so as to apply the desired torque to the wheel 4. Thereafter, the apparatus 20 may be removed from the wheel 4 by pulling the handle 28 in a reverse direction to disengage the inner and outer blocks 22 and 24 from the rim.

As illustrated, the inner and outer blocks 22 and 24, may be formed of a continuous material with the connecting member to form a gripping head 50. The gripping head 50 may be formed of any suitable material, such as, by way of non-limiting example, composite materials, steel, stainless steel, aluminium or any other suitable metal or combinations thereof. The gripping head 50 may also be formed of any suitable known method, such as, by way of non-limiting example, machining, casting or forging. Additionally, the handle may also be formed of either a continuous material with the gripping head 50 or may be secured thereto by any suitable means, such as, by way of non-limiting example, welding, fasteners or adhesives. The handle 28 may also be formed of any suitable material, such as, by way of non-limiting example, composite materials, steel, stainless steel, aluminium or any other suitable metal or combinations thereof.

With reference to FIG. 2, the inner and outer blocks 22 and 24 may optionally include inner and outer retaining ridges, 60 and 62, respectively. The inner and outer retaining ridges may comprise surfaces angled towards the connector so as to assist in retaining the rim 8 within the space between the inner and outer engaging surfaces 30 and 32 of the gripping head 50. As illustrated in FIG. 2, the inner retaining ridge 60 may be located on an inner retaining block 64 while the outer retaining ridge 62 may be located on an outer retaining block 66. The inner and outer retaining blocks may be secured to the inner and outer blocks 22 and 24 by any suitable means, such as, by way of non-limiting example, fasteners 67, adhesives, welding or the like. It will also be appreciated that the inner and outer retaining ridges 60 and 62 may be formed into the inner and outer blocks 22 and 24.

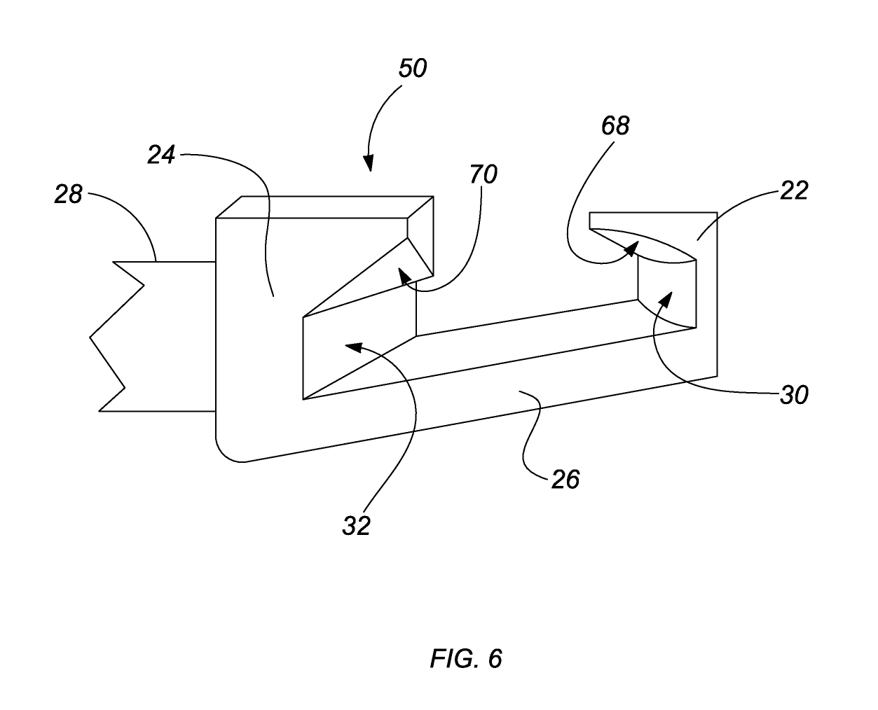

With reference to FIG. 6, the inner and outer retaining ridges may have inner and outer retaining surfaces 68 and 70, respectively. As illustrated, the inner and outer retaining surfaces 68 and 70 may be angularly oriented relative to the inner and outer engaging surfaces 30 and 32 so as to urge the rim 8 to be proximate to the connector 26 and thereby retain the rim 8 within the apparatus. It will be appreciated that for rims 8 having a larger cross sectional profile, the inner and outer retaining surfaces 68 and 70 only may engage upon the inner and outer surfaces 12 and 14 of the rim whereas for rims of smaller cross sectional profiles, both the inner and outer retaining surfaces 68 and 70 as well as the inner and outer engaging surfaces 30 and 32 may bear against the rim.

While specific embodiments of the invention have been described and illustrated, such embodiments should be considered illustrative of the invention only and not as limiting the invention as construed in accordance with the accompanying claims.

What is claimed is:

1. An apparatus for turning a railway handbrake wheel having an axis of rotation and a circumferential wheel rim located along a wheel plane perpendicular to said axis spaced apart from said axis by spokes, the apparatus comprising:
an inner block having a first engaging surface engagable upon an inner surface of the wheel rim;
an outer block having a second engaging surface engagable upon an outer surface of the wheel rim;
a connector extending between and fixedly connected to said inner and outer blocks; and
a handle extending from said outer block.

2. The apparatus of claim 1 wherein said handle extends substantially radially from said handbrake wheel when said inner and outer blocks are applied thereto.

3. The apparatus of claim 1 wherein said first engaging surface is curved.

4. The apparatus of claim 3 wherein said first surface has a curvature selected to correspond to the connection between a spoke and rim of a railway handbrake wheel.

5. The apparatus of claim 4 wherein said first surface has a radius selected to be less than 30 inches.

6. The apparatus of claim 1 wherein said inner and outer blocks are fixedly secured to said connector in opposition to each other with a space between said first and second surfaces.

7. The apparatus of claim 6 wherein said space is selected to be between 0.25 and 6 inches.

8. The apparatus of claim 1 wherein said connector extends substantially parallel to said plane of said wheel plane to a first side of said first and second blocks.

9. The apparatus of claim 1 wherein said outer block includes a raised edge extending therefrom in a direction towards said inner block at an opposed side from said connector.

10. The apparatus of claim 9 wherein said raised edge is angularly oriented relative to said first surface.

11. The apparatus of claim 1 wherein said inner block includes a raised edge extending therefrom in a direction towards said outer block at an opposed side from said connector.

12. The apparatus of claim 11 wherein said raised edge is angularly oriented relative to said second surface.
